(19) United States
(12) Patent Application Publication
(10) Pub. No.: US 2026/0160282 A1
(43) Pub. Date: Jun. 11, 2026

(54) HYDRAULIC FLUID CASE AND PILOT DRAIN FILTRATION

(71) Applicant: Evan Gruszynski, Hartford, WI (US)

(72) Inventor: Evan Gruszynski, Hartford, WI (US)

(73) Assignee: Helgesen Industries, LLC, Hartford, WI (US)

(21) Appl. No.: 19/386,536

(22) Filed: Nov. 12, 2025

Related U.S. Application Data
(63) Continuation of application No. PCT/US2024/032912, filed on Jun. 7, 2024.
(60) Provisional application No. 63/506,680, filed on Jun. 7, 2023.

(51) Int. Cl. F15B 21/041; F15B 1/26; F15B 15/18; F15B 21/00

(52) U.S. Cl. CPC F15B 21/041; F15B 1/26; F15B 15/18; F15B 21/005

(57) ABSTRACT

A hydraulic tank is provided. The hydraulic tank includes a side wall having an inlet for receiving hydraulic fluid from a hydraulic actuation circuit, an outlet for providing hydraulic fluid to the hydraulic actuation circuit, and a drain line inlet. The hydraulic tank includes a port plate having at least one drain port. The port plate is attached to the side wall over the drain inlet. A filter disc including a filter media is disposed between the port plate and the drain inlet. A gasket is positioned around the filter disc and is disposed between the port plate and the at least one side wall. The filter media is spaced apart from the port plate.

### CROSS-REFERENCE TO RELATED PATENT APPLICATIONS

This patent application is a continuation of U.S. Patent Application No. PCT/US2024/032912, filed Jun. 7, 2024, which claims the benefit of U.S. Provisional Patent Application No. 63/506,680 , filed Jun. 7, 2023, the entire teachings and disclosure of which are incorporated herein by reference thereto.

### FIELD OF THE INVENTION

This invention generally relates to hydraulic systems and, in particular, to a filtration system for drain lines in a hydraulic system.

### BACKGROUND OF THE INVENTION

In certain hydraulic systems, a pump draws hydraulic fluid from a tank and pressurizes the hydraulic fluid to move an actuator in a hydraulic actuation circuit. For the actuation, hydraulic fluid is recirculated through the system in such a manner that the hydraulic fluid is returned to the tank and drawn by the pump and pressurized again to flow through the hydraulic actuator circuit. In some systems, the hydraulic fluid flowing through the pump also lubricates the components of the pump. The hydraulic fluid used in this manner collects in the casing of the pump, and this hydraulic fluid is also recirculated to prevent the buildup of pressure in the pump casing, which can lead to failure of seals within the pump. The hydraulic fluid is removed from the casing to the hydraulic tank on a case drain line.

It is not uncommon for the hydraulic fluid on the case drain line to include debris from wear between parts in the pump or from pump failure. The debris is carried by the case drain line back to the hydraulic tank, where the debris-contaminated hydraulic fluid may be recirculated with the rest of the hydraulic fluid in the hydraulic actuation circuit. The debris in the hydraulic fluid can lead to the malfunction or failure of other components within the hydraulic system such that a pump failure can lead to a system-wide failure of the hydraulic actuator circuit.

Similarly, a hydraulic control valve may be pilot operated. Actuation of the pilot from open to closed or closed to open may be used to control the direction of flow in the hydraulic control valve. The pilot is also hydraulically actuated, and there is a drain flow from the pilot as a result of actuation. Like the case drain flow, pilot drain flow may also be contaminated with debris.

In view of the foregoing, Applicant has identified a need to limit the spread of component failure or hydraulic oil contamination in a hydraulic system.

### BRIEF SUMMARY OF THE INVENTION

According to the present disclosure, embodiments of a drain line filtration system are provided. The drain line filtration system utilizes a flat filtration disc positioned upstream of a drain inlet of a hydraulic tank to prevent debris from entering the hydraulic tank. In this way, the amount of debris caused by pump/valve wear or failure that enters the hydraulic tank is substantially reduced or eliminated, thereby limiting the possibility of contaminating the hydraulic fluid circulating in the hydraulic actuation circuit. Advantageously, the positioning of the filtration disc allows for multiple drain lines (e.g., case drain lines or pilot drain lines) to be filtered as the hydraulic fluid is returned to the hydraulic tank. Further, the construction of the drain filtration system allows for the filtration disc to be easily cleaned or replaced as needed. These and other advantages of the invention, as well as additional inventive features, will be apparent from the description of the invention provided herein.

In a first aspect, embodiments of the disclosure relate to a hydraulic tank. The hydraulic tank comprises at least one side wall comprising an inlet for receiving hydraulic fluid from a hydraulic actuation circuit, an outlet for providing hydraulic fluid to the hydraulic actuation circuit, and a drain line inlet. The hydraulic tank further comprises a port plate comprising at least one drain port. The port plate is attached to the at least one side wall over the drain line inlet. A filter disc comprising a filter media is disposed between the port plate and the drain line inlet. A gasket is positioned around the filter disc and disposed between the port plate and the at least one side wall. The filter media is spaced apart from the port plate.

In a second aspect, embodiments of the disclosure relate to the hydraulic tank according to the first aspect in which the filter media comprises a first flow area, the at least one drain port comprises a second flow area, and the first flow area is greater than the second flow area.

In a third aspect, embodiments of the disclosure relate to the hydraulic tank according to the first aspect or the second aspect in which the at least one drain port comprises a plurality of drain ports.

In a fourth aspect, embodiments of the disclosure relate to the hydraulic tank according to the third aspect in which the plurality of drain ports comprises a combined flow area and wherein the first flow area is greater than the combined flow area.

In a fifth aspect, embodiments of the disclosure relate to the hydraulic tank according to any one of the first aspect to the fourth aspect in which the hydraulic tank further comprises a positioning ring disposed within the gasket that spaces the filter media apart from the port plate.

In a sixth aspect, embodiments of the disclosure relate to the hydraulic tank according to any one of the first aspect to the fifth aspect in which the port plate and the at least one side wall are separated by a distance D and in which the filter media is spaced apart from the port plate by a first spacing S1 in a range 0D<S1≤1D.

In a seventh aspect, embodiments of the disclosure relate to the hydraulic tank according to the sixth aspect in which the hydraulic tank further comprises a supporting disc disposed between the filter media and the drain line inlet.

In an eighth aspect, embodiments of the disclosure relate to the hydraulic tank according to the seventh aspect in which the supporting disc spaces the filter media from the at least one side wall by a second spacing S2 in a range 0D<S2<1D.

In a ninth aspect, embodiments of the disclosure relate to the hydraulic tank according to the seventh aspect or the eighth aspect in which the supporting disc comprises an outer ring and a plurality of inwardly extending fingers configured to support the filter media.

In a tenth aspect, embodiments of the disclosure relate to the hydraulic tank according to the ninth aspect in which the supporting disc further comprises a inner ring concentric with the outer ring. The fingers extend from the outer ring to the inner ring.

In an eleventh aspect, embodiments of the disclosure relate to the hydraulic tank according to any of the first aspect to the tenth aspect in which the filter media comprises a mesh screen.

In a twelfth aspect, embodiments of the disclosure relate to the hydraulic tank according to the eleventh aspect in which the mesh screen has a size in a range from 20 mesh to 250 mesh (840 microns to 62 microns).

In a thirteenth aspect, embodiments of the disclosure relate to the hydraulic tank according to any of the first aspect to the twelfth aspect in which the drain line inlet comprises a plurality of substantially parallel slits, a semicircular aperture, or a circular aperture.

In a fourteenth aspect, embodiments of the disclosure relate to the hydraulic tank according to the thirteenth aspect in which the at least one sidewall further comprises at least one bleed hole disposed above the drain line inlet. Each of the at least one bleed hole is covered by the port plate.

In a fifteenth aspect, embodiments of the present disclosure relate to a hydraulic system. The hydraulic system comprises the hydraulic tank according to any one of the first aspect to the fourteenth aspect in which the hydraulic tank contains hydraulic fluid. The hydraulic system further comprises at least one actuator and a pump configured to draw the hydraulic fluid from the outlet of the hydraulic tank and pressurize the hydraulic fluid for actuation of the at least one actuator. The actuation causes return of hydraulic fluid to the inlet of the hydraulic tank. A first portion of the hydraulic fluid flowing through the pump lubricates the pump, and the first portion of the hydraulic fluid is returned to the hydraulic tank through a drain line in fluid communication with the at least one drain port.

In a sixteenth aspect, embodiments of the disclosure relate to the hydraulic system according to the fifteenth aspect in which the at least one actuator comprises a hydraulic motor. A second portion of hydraulic fluid flowing through the motor lubricates the motor, and the second portion of the hydraulic fluid is returned to the hydraulic tank through a second drain line in fluid communication with the at least one drain port.

In a seventeenth aspect, embodiments of the disclosure relate to a method for filtering hydraulic fluid on a drain line. In the method, the hydraulic fluid is drawn from a hydraulic tank through a pump. A first portion of the hydraulic fluid is used to lubricate the pump. Using the pump, a second portion of the hydraulic fluid is pressurized for use by at least one actuator. The first portion of the hydraulic fluid is returned from the pump to the hydraulic tank through the drain line. The first portion of the hydraulic fluid is filtered as the first portion of hydraulic fluid flows into a drain line inlet of the hydraulic tank by passing the first portion of hydraulic fluid through a filter media disposed over the drain line inlet. The drain line terminates at a port plate attached to the hydraulic tank, and the filter media is positioned between the port plate and the drain line inlet.

In an eighteenth aspect, embodiments of the disclosure relate to the method according to the seventeenth aspect in which the filter media is positioned between the port plate and the drain line inlet using a positioning ring and a supporting disc. The positioning ring is disposed between the port plate and the filter media, and the supporting disc is disposed between the filter media and the drain line inlet.

In a nineteenth aspect, embodiments of the disclosure relate to the method according to the seventeenth aspect or the eighteenth aspect in which the at least one actuator comprises a motor and in which the second portion of hydraulic fluid comprises a third portion of hydraulic fluid. In the method, the third portion of the hydraulic fluid is used to lubricate the motor. The third portion of the hydraulic fluid is returned from the motor to the hydraulic tank through a second drain line, and the third portion of the hydraulic fluid is filtered as the third portion of hydraulic fluid flows into the drain line inlet of the hydraulic tank by passing the third portion of hydraulic fluid through the filter media disposed over the drain line inlet. The second drain line terminates at the port plate attached to the hydraulic tank.

In a twentieth aspect, embodiments of the disclosure relate to the method according to any of the seventeenth aspect to the nineteenth aspect in which the drain line and the second drain line terminate at a first drain port and a second drain port, respectively, of the port plate. The filter media comprises a first flow area, the first and second drain ports together comprise a second flow area, and the first flow area is greater than the second flow area.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a schematic diagram of a hydraulic system, according to an exemplary embodiment;

FIG. 2 is a first perspective view of a hydraulic tank, according to an exemplary embodiment;

FIG. 3 is a second perspective view of the hydraulic tank of FIG. 2, according to an exemplary embodiment;

FIG. 4 is a partial exploded view of the drain filtration system of the hydraulic tank, according to an exemplary embodiment;

FIG. 5 is a partial cross-sectional view of the drain filtration system of the hydraulic tank, according to an exemplary embodiment;

FIGS. 6A and 6B depict a stack of a positioning ring, filter media, and supporting disc, according to an exemplary embodiment; and

FIGS. 7A and 7B depict different types of drain line inlets of the hydraulic tank, according to exemplary embodiments.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

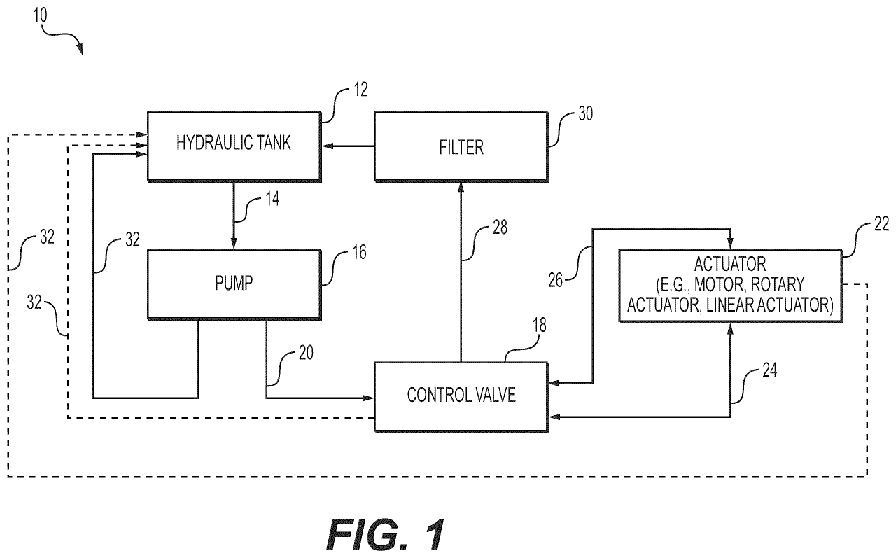

FIG. 1 depicts a schematic illustration of a hydraulic system 10 according to the present disclosure. In the hydraulic system 10, hydraulic fluid is provided in a hydraulic tank 12. The hydraulic fluid is drawn from the hydraulic tank 12 on a first line 14 via a pump 16, which imparts pressure on the hydraulic fluid. The pressurized hydraulic fluid is provided to a control valve 18 over a second line 20. The control valve 18 directs flow of the hydraulic fluid to an actuator 22, such as a motor, rotary actuator, or linear actuator. In particular, the control valve 18 may actuate the actuator 22 in a first direction by directing fluid on a third line 24, which will cause return of fluid on a fourth line 26. When the control valve 18 actuates the actuator 22 in a second direction, fluid is directed on the fourth line 26, which causes return of fluid on the third line 24. Fluid returned to the control valve 18 on either the third line 24 or fourth line 26 is returned to the hydraulic tank 12 on a fifth line 28. A filter 30 may be provided on the fifth line 28 to remove debris from the hydraulic fluid created, for example, in the pump 16, the control valve 18, or the actuator 22. While a single hydraulic actuation circuit is depicted, the hydraulic tank 12 could supply hydraulic fluid to multiple hydraulic actuation circuits, including multiple actuators 22, multiple control valves 18, and/or multiple pumps 16.

During operation of the pump 16, for example, the internal components need to be lubricated, and thus, tolerances between moving components are such that hydraulic fluid leaks around the internal components. This hydraulic fluid is collected in the outer case of the pump 16, and the hydraulic fluid is returned to the hydraulic tank 12 on a drain line 32 referred to as a “case drain” line. As will be discussed more fully below, the hydraulic fluid returned to the hydraulic tank 12 on this drain line 32 (as well as others) is filtered as it returns to the hydraulic tank 12. In one or more embodiments, the hydraulic system 10 may include multiple drain lines 32 that return hydraulic fluid to the hydraulic tank 12. For example, when the actuator 22 is a motor, the motor may also require lubrication using the hydraulic fluid, and thus, as shown in FIG. 1, the actuator 22 may also include a drain line 32 (also referred to as a “case drain” line) that returns hydraulic fluid to the hydraulic tank 12. According to embodiments of the present disclosure, hydraulic fluid returned on the drain line 32 from the actuator 22 is also filtered as it returns to the hydraulic tank 12. Still further, certain hydraulic control valves 18 are pilot operated, and a portion of the hydraulic fluid flowing to the control valve 18 may be used to actuate the pilot. Actuation of the pilot of the control valve 18 produces a drain flow, and such drain flow returned on another drain line 32 from the pilot may also be filtered as it returns to the hydraulic tank 12.

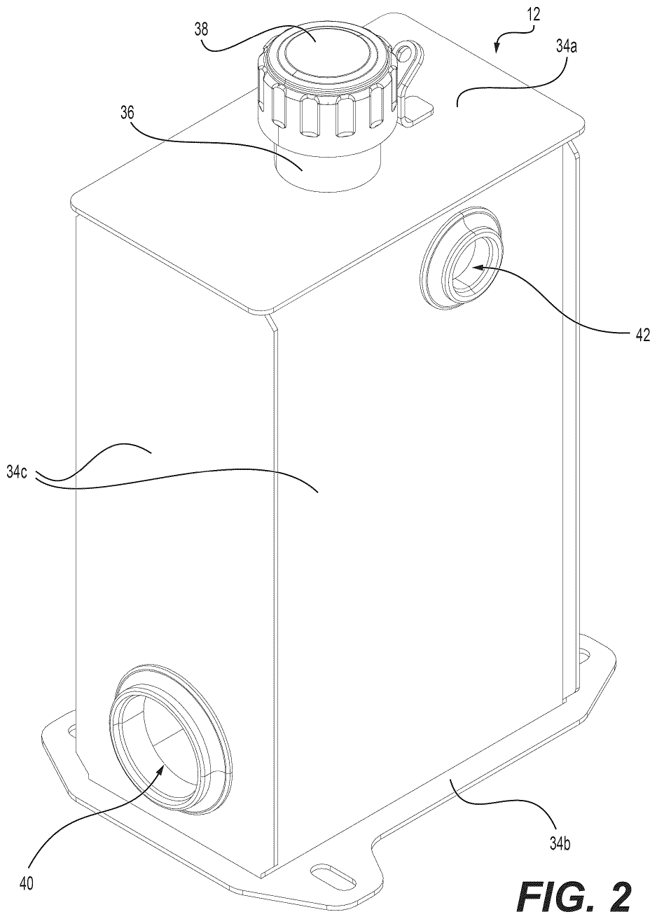

FIG. 2 depicts an embodiment of a hydraulic tank 12 having a drain line filtration system configured to filter the hydraulic fluid as the hydraulic fluid enters the hydraulic tank 12. From the view of FIG. 2, it can be seen that the hydraulic tank 12 includes a plurality of walls, including a top wall 34a, a bottom wall 34b, and at least one side wall 34c. The plurality of walls 34a-c define an interior cavity configured to hold hydraulic fluid. As shown in FIG. 2, the top wall 34a includes first port 36 having a cap 38. In one or more embodiments, the cap 38 is removed from the first port 36 to allow for hydraulic fluid to be poured through the first port 36 to fill the interior cavity. Further, in one or more embodiments, the cap 38 may provide venting of air and other gases from the interior cavity of the hydraulic tank 12.

Further, one side wall 34c includes an outlet port 40 through which hydraulic fluid flows on the first line 14 to the pump 16 (as shown in FIG. 1). The hydraulic tank 12 of FIG. 2 also includes an inlet 42 through which (filtered) hydraulic fluid is returned to the hydraulic tank 12 on the fifth line 28.

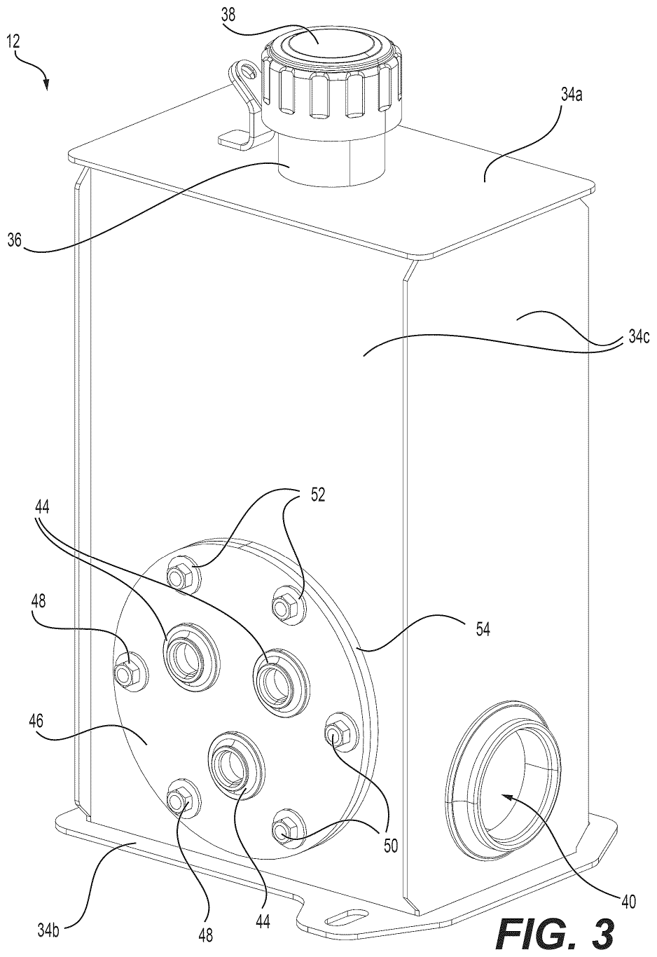

Referring now to FIG. 3, it can be seen that the hydraulic tank 12 also includes a one or more drain ports 44. The drain ports 44 are provided in a port plate 46 attached to a side wall 34c of the hydraulic tank 12. In one or more embodiments, the port plate 46 is attached to the side wall 34c using a plurality of nuts 48 threaded onto posts 50. In one or more embodiments, the posts 50 are inserted through apertures in the side wall 34c and through apertures in the port plate 46, and the posts 50 have heads that abut the interior surface of the side wall 34c. In one or more such embodiments, the heads of the posts 50 are permanently attached, such as by welding (e.g., electronic resistance welding), to the interior surface of the side wall 34c. In this way, tightening the nuts 48 on the posts 50 securely fastens the port plate 46 between the nuts 48 and the sidewall 34c. Further, as shown in the embodiment of FIG. 3, washers 52 are provided between each of the nuts 48 and the port plate 46, which may, for example, distribute the load of the nuts 48 threaded on to the posts 50.

The hydraulic tank 12 also includes a gasket 54 disposed between the port plate 46 and the side wall 34c. The gasket 54 provides a fluid-tight seal between the port plate 46 and the side wall 34c. In one or more embodiments, attaching the port plate 46 to the side wall 34c, such as by tightening the nuts 48 on the posts 50, compresses the gasket 54 between the port plate 46 and the side wall 34c to provide the fluid-tight seal.

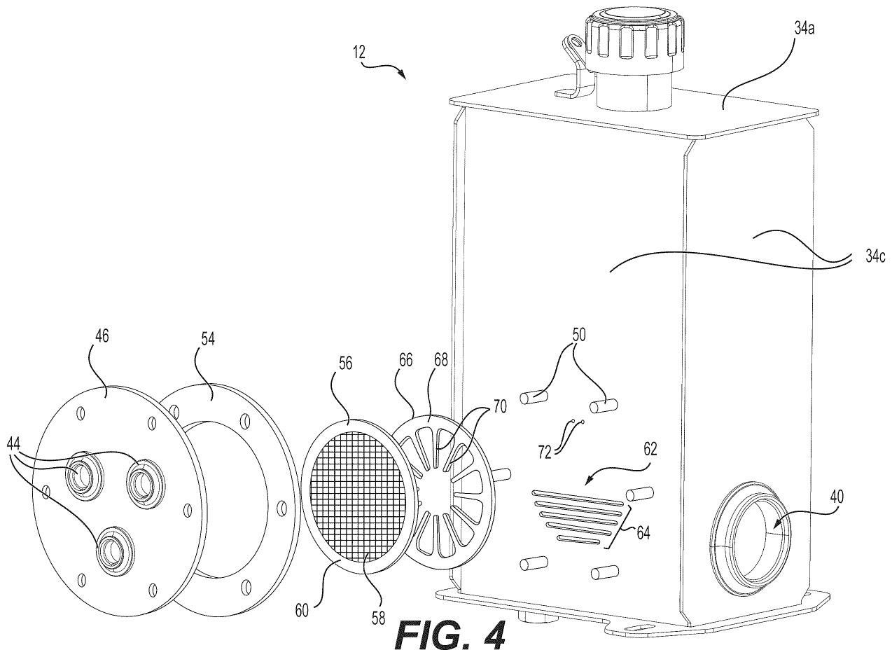

FIG. 4 depicts a partially exploded view of the hydraulic tank 12. As can be seen, besides the gasket 54, a filter disc 56 is disposed between the port plate 46 and the side wall 34c. In one or more embodiments, the filter disc 56 includes a filter media 58 and a positioning ring 60 disposed over or around a perimeter of the filter media 58. In one or more embodiments, the filter media 58 is a mesh screen having a mesh size in the range of, for example, 20 mesh to 250 mesh, in particular about 100 mesh (or metric equivalents 840 microns to 62 microns, in particular about 149 microns). In one or more embodiments, the mesh screen is a stainless-steel wire mesh screen. Other filter media 58 can also be used, such as various woven or non-woven synthetic polymer or natural fiber media. In contrast to other filters used with hydraulic systems (such as filter 30 on the fifth line 28 that returns hydraulic fluid to the hydraulic tank 12), the filter disc 56 includes a thin, flat piece of filter media 58, not a pleated and/or cylindrical cartridge. In one or more embodiments, the faces of the filter media 58 have a width and/or length that is much greater (e.g., by at least an order of magnitude) than a thickness between the faces of the filter media 58. In one or more embodiments, the filter media 58 has thickness between a first face and a second face in a range from 0.003 in to 0.035 in.

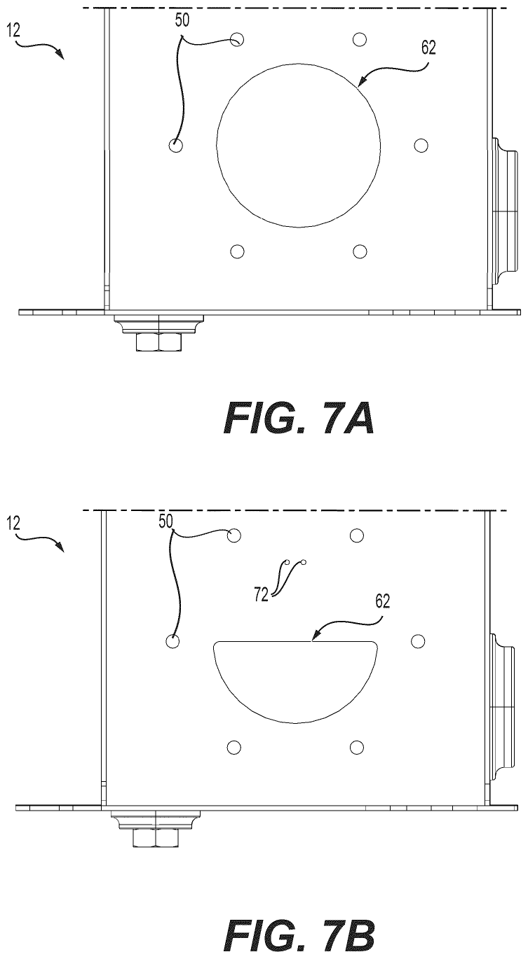

The filter disc 56 is positioned in front of a drain line inlet 62 formed in the side wall 34c of the hydraulic tank 12. In the embodiment depicted in FIG. 4, the drain line inlet 62 comprises a plurality of slits 64 cut through the side wall 34c of the hydraulic tank 12. Notwithstanding, in one or more other embodiments, the drain line inlet 62 could be a single aperture, such as a circular aperture (e.g., as shown in FIG. 7A) or a semicircular aperture (e.g., as shown in FIG. 7B). As can be seen, flow of hydraulic fluid through the one or more drain ports 44 must pass through the filter media 58 of the filter disc 56 before entering the drain line inlet 62.

In one or more embodiments, a supporting disc 66 is positioned between the filter media 58 and the drain inlet 62. As will be discussed more fully below, the supporting disc 66 prevents the filter media 58 from contacting the side wall 34c. In this regard, the supporting disc 66 includes an outer ring 68, and in one or more embodiments, such as the embodiment shown in FIG. 4, the supporting disc 66 includes a plurality of fingers 70 that extend inwardly from the outer ring 68 to provide support for the filter media 58. In one or more other embodiments, the supporting disc 66 can be any of a variety of other structures, such as a mesh scrim or connected concentric rings, among other possibilities. In one or more embodiments in which the drain line inlet 62 is an aperture substantially the same size and shape as the filter media 58, the supporting disc 66 may be only the outer ring 68 or may not be used at all as there would be no or minimal contact between the filter media 58 and the side wall 34c. Additionally, in one or more embodiments, the supporting disc 66 may be a structure unitary with or joined to the sidewall 34c, such as by welding, bonding, or machining, amongst other possibilities. Alternatively, the filter media 58 could be clamped between the side wall 34c and the positioning ring 60 or port plate 46 (e.g., based on pressure from the nuts 48 tightened onto the posts 50.

As can be seen in FIG. 4, the drain line inlet 62 includes a plurality of slits 64 that only extend about halfway up the filter media 58. In such embodiments, air can become trapped between the filter media 58 and the side wall 34c. Thus, in one or more embodiments, one or more bleed holes 72 are provided through the side wall 34c to allow any trapped air to flow through the side wall 34c to vent through the interior cavity of the hydraulic tank 12.

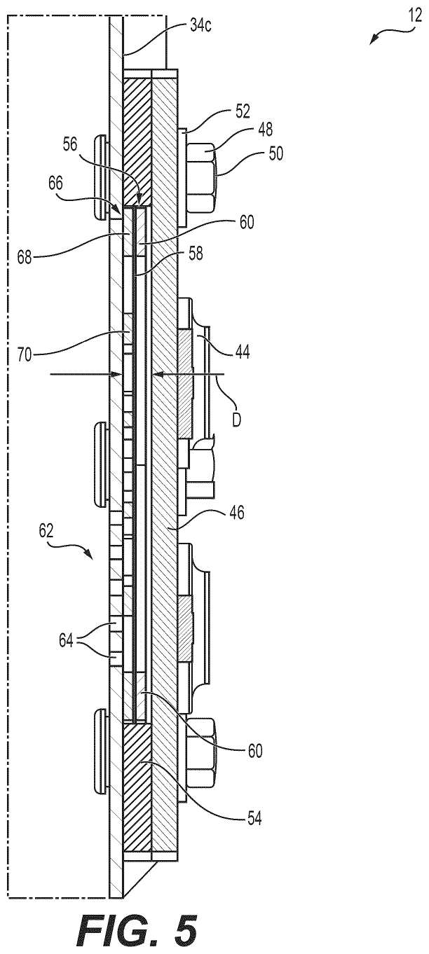

FIG. 5 depicts a partial cross-sectional view of the hydraulic tank 12 in an assembled state. As can be seen, the filter disc 56 and supporting disc 66 are positioned within the gasket 54 such that the gasket 54 surrounds the filter disc 56 and the supporting disc 66. As mentioned above, in embodiments, the supporting disc 66 may not be needed depending on the size and shape of the drain inlet 62, and in such embodiments, the gasket 54 would surround just the filter disc 56. The port plate 46 is positioned over the gasket 54 and attached to the side wall 34c such that the gasket 54 is compressed between the side wall 34c and the port plate 46, which provides a fluid-tight seal around the filter disc 56, supporting disc 66, and the drain line inlet 62. The port plate 46 includes one or more drain ports 44 through which the hydraulic fluid on one or more drain lines (e.g., the drain lines 32 as shown in FIG. 1) passes through the port plate 46. The filter media 58 of the filter disc 56 is sized such that the hydraulic fluid from each of the drain ports 44 must pass through the filter media 58 to enter the drain line inlet 62 of the hydraulic tank 12.

In this regard, the positioning ring 60 of the filter disc 56 has a thickness configured to space the filter media 58 away from the rear surface of the port plate 46. In one or more embodiments, the port plate 46 and the side wall 34c are separated by a distance D, and the positioning ring 60 is configured to space the filter media 58 away from the port plate 46 by a first spacing (S1) in a range 0D<S1≤1D, in particular at least 0.1D≤S1≤1D. For example, in one or more embodiments in which the supporting disc 66 is not used, the first spacing (S1) may be up to 1D. However, in one or more embodiments in which the supporting disc 66 is used, the first spacing (S1) may be, for example, in a range 0D<S1≤0.5D. Providing such space prevents contact between the filter media 58 and the port plate 46 that might otherwise decrease the available area of the filter media 58 through which the drain hydraulic fluid might pass. This increased surface area decreases the pressure drop of the drain hydraulic fluid passing through the filter media 58 into the hydraulic tank 12.

In a similar way, the supporting disc 66 (when provided) has a thickness configured to space the filter media 58 away from the side wall 34c of the hydraulic tank 12 to increase the available area through which the case drain hydraulic fluid can pass through the filter media 58 into the drain line inlet 62. In one or more embodiments, the supporting ring 66 is configured to space the filter media 58 away from the side wall 34c by a second spacing (S2) in a range 0D<S2<1D, in particular 0.1D≤S2≤0.5D. Accordingly, substantially the entire front and rear faces of the filter media 58 are available for flow of the drain hydraulic fluid to pass from the one or more drain ports 44 into the drain line inlet 62. That is, flow through the filter media 58 is not limited to the area of the one or more drain ports 44, and indeed, the flow area through the filter media 58 is greater than the flow area of each of the drain ports 44 as well as the combined flow area of all of the drain ports 44.

In one or more embodiments, the positioning ring 60, filter media 58, and supporting disc 66 are individual components that are stacked together when placed within the gasket 54. In one or more other embodiments, the positioning ring 60 and the filter media 58 are one component or are joined, e.g., by adhesive or welding, to form one component (e.g., filter disc 56), and the supporting disc 66 is a second component that is stacked with the positioning ring 60 and filter media 58. In still one or more other embodiments, the filter media 58 and the supporting disc 66 are one component or are joined, e.g., by adhesive or welding, to form one component, and the positioning ring 60 is a second component stacked with the filter media 58 and the supporting disc 66. In yet one or more other embodiments, the positioning ring 60, filter media 58, and the supporting disc 66 are a single component or are joined together, e.g., by adhesive or welding, to form a single component.

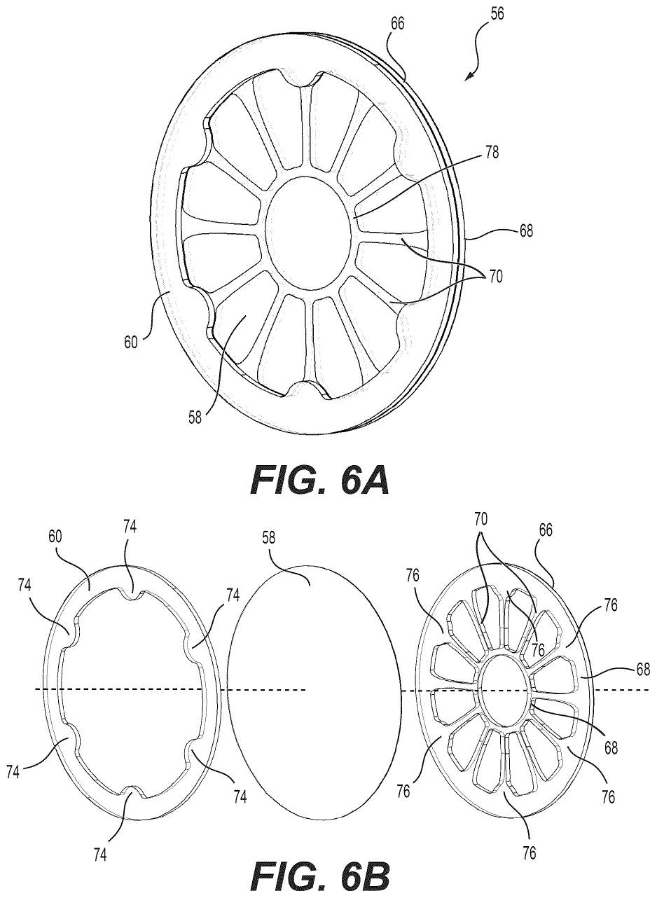

FIGS. 6A and 6B depict an example embodiment of a single component formed by joining the filter media 58, the positioning ring 60, and the supporting disc 66. As can be seen in FIGS. 6A and 6B, the positioning ring 60 includes enlarged first bonding areas 74, and the supporting disc 66 includes enlarged second bonding areas 76 around the outer ring 68. The first and second bonding areas 74, 76 of the positioning ring 60 and the supporting disc 66 are aligned and joined together, such as by spot welding. If the filter media 58 is metal, such as a metal mesh screen, the filter media 58 may also be spot welded together with the positioning ring 60 and the supporting disc 66. In any case, the filter media 58 is held between the positioning ring 60 and the supporting disc 66 that are joined together to form the single component.

Additionally, FIGS. 6A and 6B depict another embodiment of the supporting disc 66 in which the fingers 70 extend inwardly from the outer ring 68 to an inner concentric ring 78. As compared to the embodiment shown in FIG. 4, which does not include an inner concentric ring 78, the embodiment of the supporting disc 66 shown in FIGS. 6A and 6B provides additional support for the filter media 58 albeit while also potentially restricting some drain flow into the hydraulic tank because of the increased coverage area of the supporting disc 66. In this regard, the particular type of supporting disc 66 can be selected based on the type of drain line inlet 62 on the hydraulic tank 12.

For example, as shown in FIG. 4, the drain line inlet 62 is a plurality of slits 64. Because of the already relatively restricted flow area of the drain line inlet 62, it may be beneficial to use the supporting disc 66 without the inner concentric ring 78, providing increased flow area through the media 58. Because of the location of the slits 64 of the drain line inlet 62, if the inner concentric ring 78 is used on the supporting disc 66, a pocket is formed because, on the back of the supporting disc 66, the fingers 70 block the flow from the top to the bottom, reducing the effective area. In FIG. 7A, the drain line inlet 62 is a circular aperture, providing the maximum flow area through the drain line inlet 62 but also providing the least support for the filter media 58. In such an embodiment, the supporting disc 66 with the inner concentric ring 78 shown in FIGS. 6A and 6B may be beneficial for providing enhanced support for the filter media 58. In FIG. 7B, the drain line inlet 62 is a semicircular aperture, providing a flow area that is restricted relative to the circular aperture of FIG. 7A, and thus, the supporting disc 66 without the inner concentric ring 68 as shown in FIG. 4 may be used depending on the desired throughput. Further, as shown in FIG. 7B, the hydraulic tank 12 includes bleed holes 72 to allow venting of air trapped on the inside of the hydraulic tank 12 because of the restricted drain inlet 62 aperture size.

In a hydraulic system, such as the schematic hydraulic system 10 shown in FIG. 1, there may be multiple elements that utilize a drain line to return hydraulic fluid to the hydraulic tank 12. For example, the hydraulic system 10 may have a drain line 32 for the pump 16 as shown in FIG. 1, for the actuator 22 in the form of one or more hydraulic motors (e.g., for powering wheels, tracks, or other rotating implements), or for a pilot drain of the control valve 18. In another example, the hydraulic system 10 could include multiple pumps 16, multiple actuators 22 in the form of motors, and/or multiple control valves 18 that are pilot operated that each have a drain line 32, and in still another example, the hydraulic system 10 could include multiple pumps 16, multiple actuators 22 in the form of motors, and multiple pilot-operated control valves 18 that each have a drain line 32. According to embodiments of the present disclosure, each of the drain lines 32 from the multiple pumps 16, actuators 22 (motors), and/or pilot-operated control valves 18 can be returned to the hydraulic tank 12 (such as shown in FIGS. 2-5) through respective drain ports 44 in the port plate 46. In this way, all of the hydraulic fluid from the drain lines 32 can be directed through the filter media 58, and separate filtration of the individual drain lines can be avoided. In practice, the number of drain lines that can be accommodated by the port plate 46 and filter disc 56 is not particularly limited, and the size of the port plate 46 and filter disc 56 can be increased or decreased as necessary to match the number of drain lines. Thus, while the figures depict three drain ports 44, other embodiments of the hydraulic tank 12 may have one drain port 44, two drain ports 44, or more than three drain ports 44.

Further, the construction of the drain line filtration system allows for ease of cleaning or replacement of the filter media 58. In particular, the port plate 46 is removed from attachment to the side wall 34c (e.g., by removing nuts 48 and washers 52 from posts 50), and the filter disc 56 or filter media 58 can be wiped clean or replaced with a new filter disc 56 or filter media 58. Such ease of cleaning and replacement is in contrast to other filtration systems, such as suction strainers that are located on the inside of the hydraulic tank. To access the suction strainers, the hydraulic tank has to be opened and the hydraulic fluid drained. Further, because of the placement of the suction strainer within the hydraulic tank, the debris is not prevented from entering the tank, and cleaning the debris from inside the tank is more complicated. In still other conventional filtration devices, pleated and/or cylindrical cartridges are used, which are large and take up space in the hydraulic system and which must be provided on each drain line. Thus, the presently disclosed drain line filtration system provides a simpler, more compact, and more accessible solution to the problem of filtering hydraulic fluid in drain lines.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventor for carrying out the invention. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A hydraulic tank, comprising
at least one side wall comprising an inlet for receiving hydraulic fluid from a hydraulic actuation circuit, an outlet for providing hydraulic fluid to the hydraulic actuation circuit, and a drain line inlet;
a port plate comprising at least one drain port, the port plate being attached to the at least one side wall over the drain line inlet;
a filter disc comprising a filter media, the filter disc being disposed between the port plate and the drain line inlet; and
a gasket positioned around the filter disc and disposed between the port plate and the at least one side wall;
wherein the filter media is spaced apart from the port plate.

2. The hydraulic tank of claim 1, wherein the filter media comprises a first flow area, the at least one drain port comprises a second flow area, and the first flow area is greater than the second flow area.

3. The hydraulic tank of claim 2, wherein the at least one drain port comprises a plurality of drain ports.

4. The hydraulic tank of claim 3, wherein the plurality of drain ports comprises a combined flow area and wherein the first flow area is greater than the combined flow area.

5. The hydraulic tank of claim 1, further comprising a positioning ring disposed within the gasket that spaces the filter media apart from the port plate.

6. The hydraulic tank of claim 1, wherein the port plate and the at least one side wall are separated by a distance D and wherein the filter media is spaced apart from the port plate by a first spacing S1 in a range 0D<S1≤1D.

7. The hydraulic tank of claim 1, further comprising a supporting disc disposed between the filter media and the drain line inlet.

8. The hydraulic tank of claim 7, wherein the supporting disc spaces the filter media from the at least one side wall by a second spacing S2 in a range 0D<S2<1D.

9. The hydraulic tank of claim 7, wherein the supporting disc comprises an outer ring and a plurality of inwardly extending fingers configured to support the filter media.

10. The hydraulic tank of claim 9, wherein the supporting disc further comprises an inner ring concentric with the outer ring, the fingers extending from the outer ring to the inner ring.

11. The hydraulic tank of claim 1, wherein the filter media comprises a mesh screen.

12. The hydraulic tank of claim 11, wherein the mesh screen has a size in a range from 20 mesh to 250 mesh (or 840 microns to 62 microns).

13. The hydraulic tank of claim 1, wherein the drain line inlet comprises a plurality of substantially parallel slits, a semicircular aperture, or a circular aperture.

14. The hydraulic tank of claim 13, wherein the at least one side wall further comprises at least one bleed hole disposed above the drain line inlet, each of the at least one bleed hole being covered by the port plate.

15. A hydraulic system, comprising:
the hydraulic tank of claim 1 containing hydraulic fluid;
at least one actuator;
a pump configured to draw the hydraulic fluid from the outlet of the hydraulic tank and pressurize the hydraulic fluid for actuation of the at least one actuator, the actuation causing return of hydraulic fluid to the inlet of the hydraulic tank;
wherein a first portion of the hydraulic fluid flowing through the pump lubricates the pump, the first portion of the hydraulic fluid being returned to the hydraulic tank through a first drain line in fluid communication with the at least one drain port.

16. The hydraulic system of claim 15, wherein the at least one actuator comprises a hydraulic motor, wherein a second portion of hydraulic fluid flowing through the motor lubricates the motor, and wherein the second portion of the hydraulic fluid is returned to the hydraulic tank through a second drain line in fluid communication with the at least one drain port.

17. A method for filtering hydraulic fluid on a drain line, comprising:
drawing the hydraulic fluid from a hydraulic tank through a pump;
using a first portion of the hydraulic fluid to lubricate the pump;
pressurizing, using the pump, a second portion of the hydraulic fluid for use by at least one actuator;
returning the first portion of the hydraulic fluid from the pump to the hydraulic tank through the drain line;
filtering the first portion of the hydraulic fluid as the first portion of the hydraulic fluid flows into a drain line inlet of the hydraulic tank by passing the first portion of the hydraulic fluid through a filter media disposed over the drain line inlet;
wherein the drain line terminates at a port plate attached to the hydraulic tank and wherein the filter media is positioned between the port plate and the drain line inlet.

18. The method of claim 17, wherein the filter media is positioned between the port plate and the drain line inlet using a positioning ring and a supporting disc, the positioning ring being disposed between the port plate and the filter media and the supporting disc being disposed between the filter media and the drain line inlet.

19. The method of claim 17, wherein the at least one actuator comprises a motor, wherein the second portion of the hydraulic fluid comprises a third portion of the hydraulic fluid, and wherein the method further comprises:
using the third portion of the hydraulic fluid to lubricate the motor;
returning the third portion of the hydraulic fluid from the motor to the hydraulic tank through a second drain line;
filtering the third portion of the hydraulic fluid as the third portion of hydraulic fluid flows into the drain line inlet of the hydraulic tank by passing the third portion of hydraulic fluid through the filter media disposed over the drain line inlet;
wherein the second drain line terminates at the port plate attached to the hydraulic tank.

20. The method of claim 19, wherein the drain line and the second drain line terminate at a first drain port and a second drain port, respectively, of the port plate; and
wherein the filter media comprises a first flow area, the first and second drain ports together comprise a second flow area, and the first flow area is greater than the second flow area.
